(19) United States
(12) Patent Application Publication
(10) Pub. No.: US 2008/0260118 A1
(43) Pub. Date: Oct. 23, 2008

(54) PRODUCT, METHOD AND SYSTEM FOR ENHANCED VOICEMAIL MANAGEMENT

(75) Inventor: Ruthie D. Lyle, Durham, NC (US)

Correspondence Address: LEE LAW, PLLC;IBM CUSTOMER NUMBER, P.O. BOX 189, PITTSBORO, NC, 27312, US

(73) Assignee: International Business Machines Corporation, Armonk, NY (US)

(21) Appl. No.: 11/737,976

(22) Filed: Apr. 20, 2007

(51) Int. Cl. H04M 1/652

(52) U.S. Cl. 379/88.23

(57) ABSTRACT

The invention discloses enhanced voicemail system management through user-defined “access rules” that can be modified by a telephone account owner to provide permission and/or set a time duration for recording a message left by an incoming caller.

### TECHNICAL FIELD

The invention relates to telephone voicemail systems for recording messages left by incoming callers.

### BACKGROUND

Conventional telephone voicemail message recording systems commonly have two operating states (i.e., “off’ and “on”), allowing callers to leave messages for the called voicemail user when the system is in the “on” state and preventing callers from leaving voicemail messages when the system is in the “off” state. Typical voicemail systems also allocate a limited amount of storage space to each user for retaining new and existing recorded messages, and no additional messages can be stored when the limit is reached unless the user periodically removes (or “cleans out”) messages from the storage space. Current voicemail systems also typically place a maximum time limit on the duration of a message (which is generally set to be the same length of time for each recorded message).

These features create two drawbacks to current voicemail systems, since a user cannot select the specific incoming call(ers) that are permitted to leave messages or the maximum recording duration of a message (on a “per call” basis). The invention solves those problems by providing enhanced management of these voicemail features, so that voicemail storage space is not wasted on unwanted messages and so important calls can be provided with a longer message recording duration.

### SUMMARY OF THE INVENTION

The invention provides enhanced voicemail system management through user-defined “access rules” that provide permission and/or set a time duration for recording a message left by an incoming call(er). Specifically, a product, method and system is provided that allows a telephone account user to control voicemail access through selection of the incoming calls that are authorized to leave messages and/or by defining the time limit for recording a message. The invention allows the account owner to set and modify parameters for these voicemail features that permit individual incoming calls to be handled automatically by the system according to the created settings.

It is therefore an object of the present invention to provide enhanced voicemail system management through user-defined “access rules” that provide permission and/or set a time duration for recording a message left by an incoming call(er).

It is another object of the present invention to provide a product, method and system that allows an account user to control voicemail access through selection of the incoming calls that are authorized to leave messages and/or by defining the time limit for recording a message.

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DETAILED DRAWINGS

FIG. 1 illustrates a flowchart outlining operation of a telephone voicemail system according to the invention.

### DETAILED DESCRIPTION OF THE PREFERRED EMBODIMENTS

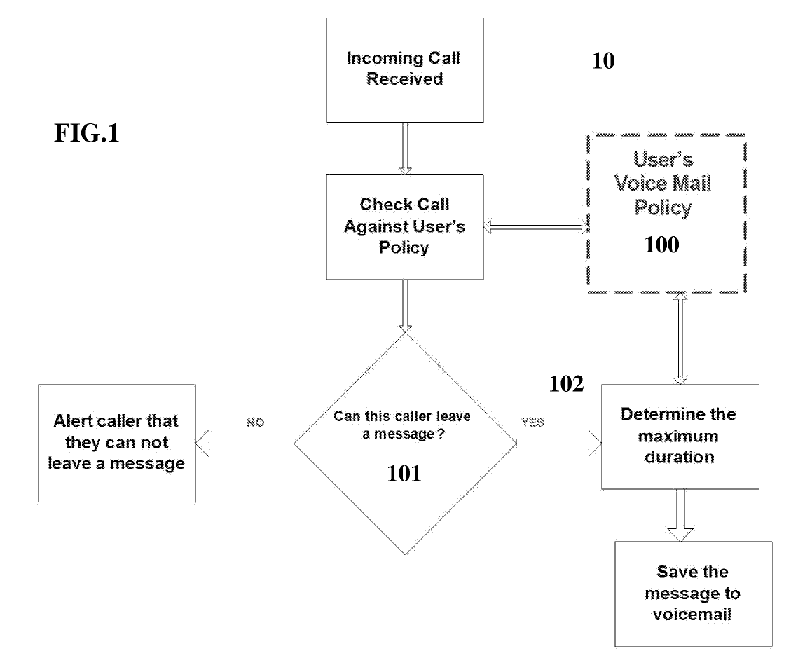

FIG. 1 illustrates a flowchart outlining the preferred operation of a voicemail system 10 for recording messages left by incoming callers that can be used with any conventional or computerized wired or wireless telephone system or voice communications network. FIG. 1 provides voicemail system management through user-defined “access rules” 100 that can be modified by a telephone account owner to define the permission and/or time duration for recording a message left by an incoming caller. The polic(ies) set by rules 100 allow an account user to control voicemail access by selecting the incoming calling telephone number(s) (each presumably associated with a known caller) authorized to leave messages 101 and/or by defining the maximum time limit 102 for recording a message. The system illustrated in FIG. 1 allows the account owner to set parameters for these voicemail features that permit incoming calls to be handled automatically according to the created settings on an individual (“per call”) basis.

For example, “permission access rules” 101 can be defined by the voicemail account owner to use call(er) identification (“call ID”) information to (a) accept incoming messages only from calling telephone numbers known to the voicemail user (i.e. stored in an “address book” which can locally reside on the telephone device used by the account owner or can be stored at a remote location managed by the network carrier maintaining the account); (b) block voicemail system access for any incoming caller that does not provide required identification information (such that an incoming call is accepted if the caller provides the requested information when prompted to do so); (c) use account call history to determine if a caller is authorized to leave a message (i.e. when the calling telephone number is stored in the list of outgoing, incoming and/or missed calls for the account); (d) accept messages only from callers using accounts existing on the same communications network; and/or (e) prevent an individual caller (according to any of the policies set by the voicemail user) from leaving more than a predefined number of messages within a particular time frame.

As another example, “duration access rules” 102 can be used by the voicemail account owner to define the time limit for recording a message by (a) allowing a message to be recorded for a predefined maximum (“X”) duration if the incoming caller meets a certain criterion (for example has a known telephone number stored in the address book); (b) allowing the recording of a message for a (“Y”) duration less (or otherwise different) than the predefined maximum (i.e., Y<X) if the incoming caller is unknown or does not meet another specified criterion (i.e., has a telephone number that is not listed in the address book of the account user); (c) decreasing (or otherwise altering) the duration for subsequent messages recorded by a given incoming caller who has left a predefined number (“H”) of messages within a certain period of time; (d) adjusting the specified maximum recording duration as a function/percentage of remaining voicemail storage space when the amount of available space is reduced below a threshold value; (e) providing a prerecorded message to notify an incoming caller of the current permitted time limit for leaving a message (for example “you have five (5) seconds to record your message”); and/or (f) providing a summary of the number of calling attempts made since the most recent message left by an incoming caller in cases where that caller is restricted from leaving additional messages (or declines to leave an additional message) during subsequent calls to the voicemail owner (for example “Lamont called 13 times since recording his last voicemail without leaving an additional message”).

While certain preferred features of the invention have been shown by way of illustration, many modifications and changes can be made that fall within the true spirit of the invention as embodied in the following claims, which are to be interpreted as broadly as the law permits to cover the full scope of the invention, including all equivalents thereto.

What is claimed is:

1. A system comprised of voice communication components configured to allow a voicemail user to control access for recording a message by executing at least the following modifiable instructions:
(a). permission rules configured for selecting one or more incoming calls authorized to leave messages; or
(b). duration rules configured to set a time limit for recording a message left in an authorized call;
wherein individual incoming calls are handled automatically by the voicemail system according to the rules set by the user.

2. The system of claim 1 wherein the permission rules use call identification information to:
(a). accept messages only from callers known to the voicemail user; or
(b). prevent voicemail access for any caller that does not provide identification information; or
(c). query voicemail account call history to determine if a caller is authorized to leave a message; or
(d). accept messages only from callers using the same communication system; or
(e). prevent a caller from leaving more than a predefined number of messages within a particular time frame.

3. The system of claim 1 wherein the duration rules are used to define the time limit for recording a message by applying one or more of the following criteria:
(a). allowing a message to be recorded for a predefined maximum time limit if the caller has a known telephone number; or
(b). allowing a message to be recorded for a duration different than the maximum time limit if the caller is unknown; or
(c). altering the time limit for subsequent messages recorded by a caller; or
(d). adjusting the recording duration as a function of remaining voicemail storage space; or
(e). notifying a caller of the time limit permitted for leaving a message; or
(f). identifying the number of calling attempts made since the last message left by a caller; or
(g). preventing a caller from leaving more than a predefined number of messages within a particular time frame.

4. The voicemail system of claim 1 wherein the components are configured for use with a conventional or computerized wired or wireless telephone system or voice communications network.

5. A method of using a system comprised of voice communication components configured to allow a voicemail user to control access for recording a message by carrying out at least the following steps for executing the following modifiable instructions:
(a). configuring permission rules for selecting one or more incoming calls authorized to leave messages; or
(b). configuring duration rules to set a time limit for recording a message left in an authorized call;
wherein individual incoming calls are handled automatically by the voicemail system according to the rules set by the user.

6. The method of claim 5 wherein the permission rules use call identification information to:
(a). accept messages only from callers known to the voicemail user; or
(b). prevent voicemail access for any caller that does not provide identification information; or
(c). query voicemail account call history to determine if a caller is authorized to leave a message; or
(d). accept messages only from callers using the same communication system; or
(e). prevent a caller from leaving more than a predefined number of messages within a particular time frame.

7. The method of claim 5 wherein the duration rules are used to define the time limit for recording a message by applying one or more of the following criteria:
(a). allowing a message to be recorded for a predefined maximum time limit if the caller has a known telephone number; or
(b). allowing a message to be recorded for a duration different than the maximum time limit if the caller is unknown; or
(c). altering the time limit for subsequent messages recorded by a caller; or
(d). adjusting the recording duration as a function of remaining voicemail storage space; or
(e). notifying a caller of the time limit permitted for leaving a message; or
(f). identifying the number of calling attempts made since the last message left by a caller; or
(g). preventing a caller from leaving more than a predefined number of messages within a particular time frame.

8. The method of claim 5 wherein the components are configured for use with a conventional or computerized wired or wireless telephone system or voice communications network.

9. A voice communication product comprised of components configured to allow a voicemail user to control access for recording a message by executing at least the following modifiable instructions:
(a). permission rules configured for selecting one or more incoming calls authorized to leave messages; or
(b). duration rules configured to set a time limit for recording a message left in an authorized call;
wherein individual incoming calls are handled automatically by the voicemail system according to the rules set by the user.

10. The product of claim 9 wherein the permission rules use call identification information to:
(a). accept messages only from callers known to the voicemail user; or
(b). prevent voicemail access for any caller that does not provide identification information; or
(c). query voicemail account call history to determine if a caller is authorized to leave a message; or
(d). accept messages only from callers using the same communication system; or
(e). prevent a caller from leaving more than a predefined number of messages within a particular time frame.

11. The product of claim 9 wherein the duration rules are used to define the time limit for recording a message by applying one or more of the following criteria:
(a). allowing a message to be recorded for a predefined maximum time limit if the caller has a known telephone number; or
(b). allowing a message to be recorded for a duration different than the maximum time limit if the caller is unknown; or
(c). altering the time limit for subsequent messages recorded by a caller; or
(d). adjusting the recording duration as a function of remaining voicemail storage space; or
(e). notifying a caller of the time limit permitted for leaving a message; or
(f). identifying the number of calling attempts made since the last message left by a caller; or
(g). preventing a caller from leaving more than a predefined number of messages within a particular time frame.

12. The product of claim 9 wherein the components are configured for use with a conventional or computerized wired or wireless telephone system or voice communications network.
